(19) United States
(12) Patent Application Publication
(10) Pub. No.: US 2020/0173590 A1
(43) Pub. Date: Jun. 4, 2020

(54) FLUID LINE COUPLING

(71) Applicant: E I M Research Pty Ltd, Port Adelaide (AU)

(72) Inventor: Kevin BARTOLO, North Haven (AU)

(21) Appl. No.: 16/612,331

(22) PCT Filed: May 9, 2018
(86) PCT No.: PCT/AU2018/050424

§ 371 Date: Nov. 8, 2019

(30) Foreign Application Priority Data
May 9, 2017 (AU) 2017901707
Dec. 15, 2017 (AU) 2017905021

(51) Int. Cl. F16L 37/26

(52) U.S. Cl. CPC F16L 37/26

(57) ABSTRACT

This disclosure relates to a quick coupling connector for fluid lines, which is operable by traverse movement of a first and second coupling member. Specifically, the coupling includes a first coupling member having a linear cam surface inclined relative to the longitudinal axis of a channel in a body of the first coupling member, and a second coupling member including a follower, the follower configured to engage the linear cam surface of the first coupling member, wherein movement of the follower along the linear cam surface brings the coupling ends of the first and second coupling members into sealing engagement.

### PRIORITY CLAIM

This applications claims priority from Australian provisional patent application number 2017901707 filed on 9 May 2017, and Australian provisional patent application number 2017905021 filed on 15 Dec. 2017, the entire contents of which are to be taken as incorporated herein by this reference.

### TECHNICAL FIELD

The present invention relates to a coupling for coupling together of fluid lines such as hoses, pipes or tubes to permit the continuous flow of fluid therethrough, as well as the coupling of such fluid lines to outlets and inlets such as taps, valves or faucets. Particularly, the present invention relates to a coupling which is actuated by movement of coupling members in a transverse direction, relative to each other.

### BACKGROUND OF THE INVENTION

Fluid lines such as hoses, pipes, or other such tubing, are routinely used to facilitate the flow of fluids from one location to another. Typically, such fluid lines require coupling to an outlet and/or an inlet, such as a tap, valve or faucet. Moreover, in some instances, it is desirable to connect more than one fluid line, in which case the multiple lines need to be coupled in a sealed manner.

There are many different types of fluid lines known in the art, which encompass a range of sizes and uses. These include small diameter (12 mm to 18 mm) garden hoses to larger diameter (1 inch or greater) fluid lines useful when larger flow rates are needed. Several factors can influence the type of coupling required for coupling fluid lines. These factors include the type and size of fluid line being used, the fluid flowing through the line and the coupling, and the pressure of the fluid travelling through the line.

The simplest coupling is a friction coupling whereby the diameter of the coupling is different to the diameter of the fluid line, with one fitting inside the other and held in place by way of friction. However, this type of coupling has the limitation that it cannot withstand moderate pressure. Consequently, connecting devices have been developed, that have retaining means that secure two or more components of a coupling in a sealed connection.

One such retaining means is provided by a rotatable collar connected to one coupling member with the collar including a screw thread, while a reciprocal screw thread is provided on a corresponding second coupling member. The two coupling members are brought into engagement and secured together by rotating the collar.

This type of coupling provides a secure connection and prevents axial movement of the two coupling members away from each other. Furthermore, rotation of the collar can be used to ensure that the two coupling members are in sealed engagement, with torsion of the collar forcing the two coupling members together. As such, this type of coupling can be useful in high pressure environments or when a tight seal needs to be maintained.

However, this type of coupling requires significant dexterity to use and cannot be quickly engaged and released. Consequently, when large and heavy fluid lines are used, supporting the fluid line in an appropriate position whereby the two threads align, while also rotating the collar, can be difficult. Further, as the diameter of the collar increases, in order to correspond to larger diameter fluid lines, manual rotation of the collar becomes more difficult and tools, such as a wrench or a spanner, may be required.

Quick-connect couplings have been developed to overcome some of the limitations described above. One commonly used quick-connect coupling is disclosed in U.S. Pat. No. 4,673,199 A. This coupling comprises a first member including a central bore for accommodation of a spigot on the second coupling member. The first member also includes an outer-sleeve surrounding it, the outer-sleeve being capable of axial sliding movement between a first and second position, together with a plurality of locking members. The locking members project into the bore of the first member, with each locking member being capable of movement between a locked position projecting into the bore to retain the spigot within the bore, and an unlocked position, in which the locking member is retracted from the bore to enable the spigot to be withdrawn.

In this coupling, movement of the locking members between the locked and unlocked positions is dependent on axial movement of the outer sleeve. The coupling is thus operated by bringing the two coupling members into engagement by axial movement thereof to position the spigot on the first member in the bore of the second member. The spigot is retained in the bore by sliding the outer-sleeve from a first position to a second position, which forces the locking members into the bore and secures them in place where they engage with the spigot in the bore.

This type of coupling allows for the rapid coupling and uncoupling of fluid lines. However, the coupling requires the spigot to be placed in the bore, and then maintained within the bore while the outer sleeve is moved. Again this requires a degree of dexterity, and can be difficult when using larger hoses, which have significant weight. As such, use of quick-connect couplings, such as that discussed above, has generally been limited to light-weight and low-pressure applications.

There is a need for a fluid line coupling that can be quickly coupled and uncoupled without significant dexterity and, that is easily operable when using large or heavy hoses.

Before turning to a summary of the present invention, it must be appreciated that the above description of the prior art has been provided merely as background to explain the context of the invention. It is not to be taken as an admission that any of the material referred to was published or known, or was a part of the common general knowledge in the relevant art.

Finally, some aspects of the present invention, that may ultimately be claimed in isolation (and not in an in-use environment), may nonetheless be difficult to describe and understand in isolation. Therefore, throughout the specification, positional terms such as up, down, forward, rearward, and the like, may be used to describe the orientation of the invention in an in use context. Of course, it must be appreciated that the use of such descriptions, and the use of the abovementioned spatial relationships, to define the present invention, is not to be seen as a limitation and certainly is not to be seen as a limitation only to the in-use environment, unless that intention is clearly stated.

### SUMMARY OF THE INVENTION

The present invention provides a fluid line coupling including a first coupling member and a second coupling member;

each of the first and second coupling members including a body having a forward coupling end and a rearward connecting end, each body having a longitudinally-extending channel passing therethrough to permit the flow of fluid from the connecting end to the coupling end;

the body of the first coupling member including a linear cam surface inclined relative to the longitudinal axis of the channel;

the body of the second coupling member including a follower, the follower configured to engage the linear cam surface of the first coupling member,

wherein movement of the follower along the linear cam surface brings the coupling ends of the first and second coupling members toward each other and into sealing engagement.

The inclined configuration of the linear cam surface of the first coupling member, in cooperation with the follower of the second coupling member, facilitates the coupling of the first and second coupling members into sealable engagement by moving the coupling members, relative to each other, in a linear direction generally transverse to the longitudinal axis of the longitudinally-extending channel. This movement brings the coupling ends into contact and the channels into axial alignment, thereby allowing fluid to flow from the first coupling member to the second coupling member. The coupling members can subsequently be uncoupled by moving the coupling members in the opposing direction. This allows relatively easy engagement and disengagement of the fluid line coupling, without the need for rotation, multiple movements, or the actuation of retention means to facilitate the sealable engagement of the coupling.

Furthermore, the direction of movement of the first and second coupling members to engage and disengage the fluid line coupling is in a direction generally transverse to the direction of force applied by the fluid flowing through the coupling. Consequently, the present fluid line coupling is resistant to having its sealed engagement disrupted by force provided by fluid flowing through, or static within, the coupling. This is particularly advantageous in high-pressure environments such as hydraulic hoses, or when flowing fluid may be stopped creating a pressure spike (for example water hammer in a garden hose).

In some embodiments, the coupling end of at least the first coupling members is configured relative to the linear cam surface such that once in sealable engagement with the coupling end of the second coupling member, the coupling ends of the first and second coupling members prevent further movement of the follower along the linear cam surface. As such, the couplings are maintained in sealing engagement until the couplings are moved in the opposing direction to move the coupling ends away from each other.

In one non-limiting ‘in use’ embodiment, the first coupling member can be fixed in a set position. For example, the connecting end of the first coupling member is attached to, or integral with, a tank, container or the like (for example as a valve, tap or faucet). In this set position, the first coupling member is oriented such that it has a top, bottom and two lateral sides. In one embodiment, the first coupling member is fixed in an orientation such that, in use, the linear cam surface is inclined in a diagonal direction from the bottom and rearward connecting end of the body upward toward the top and forward coupling end. In this embodiment, the end of the linear cam surface closest to the coupling end is above the end of the linear cam surface closest to the connecting end. In one embodiment, the first coupling member is fixed in an orientation such that, in use, the linear cam surface is vertically inclined such that it is generally perpendicular to the longitudinal axis of the longitudinally-extending channel.

In preferred forms of the above embodiments, the forward coupling end of the first coupling member is provided such that at least a portion of the coupling end is closer to the linear cam surface than an opposing portion of the coupling end. In the above orientation, the portion of the coupling end closest to the linear cam surface is positioned above the portion of the coupling end further from the linear cam surface.

In some embodiments, the coupling end of the first coupling member is provided by a face intersected by the longitudinally-extending channel to form a coupling opening, wherein at least a portion of the face is disposed at an angle relative to the linear cam surface. In some embodiments, one portion of the face of the coupling end is closer to the linear cam surface relative to an opposing portion of the face of the coupling end. In some embodiments, the face is planar and at an angle relative to the linear cam surface, such that one end of the face tends toward the linear cam surface, or, in some embodiments, converges at an apex with the linear cam surface.

In the above orientations, the first and second coupling members are coupled by moving the second coupling member from above the first coupling member, downward into axial alignment with the first coupling member, such that the follower engages a leading end of the linear cam surface and moves along the linear cam surface toward a trailing end during coupling. This moves the coupling ends of the first and second coupling members toward each other and into sealing engagement. The orientation of the coupling end of the first coupling member, relative to the linear cam surface is such that once the coupling ends of the first and second coupling members are in sealed engagement, the engagement of the coupling ends may prevent further movement of the second coupling member downwardly. This therefore prevents further movement of the follower along the linear cam surface.

These embodiments have the advantage that when the first coupling member is in a fixed position, the weight of the second coupling member, and any fluid line connected thereto, provides a force in a downward direction, generally traverse to the longitudinal axis of the longitudinally extending channel. This assists in bringing the coupling ends into engagement and maintaining them in engagement. As such, the weight of the second coupling member and any fluid lines attached, may assist in providing and maintaining the sealed engagement of the first and second coupling members. Consequently, the fluid line coupling of the present invention is particularly (but not exclusively) useful when using large diameter, or heavy, fluid lines.

Further, the relatively simple movement of the coupling members may allow both hands to be used to take the weight of the fluid line. By way of comparison, coupling members that require separate operation of a retaining means, such as rotation of a collar, to couple the two coupling members, often require one hand to support the weight of the coupling member while the other hand actuates the retaining means.

The term “coupling end” as used throughout this specification refers to the end portion of the bodies of the first and second coupling members that engage each other when the coupling members are coupled. This engagement allows the longitudinally-extending channel passing through the body of the first coupling member to be in fluid communication with the longitudinally-extending channel passing through the body of the second coupling member. Consequently, when the coupling members are coupled, fluid can pass from the connecting end of the first coupling member to the connecting end of the second coupling member.

The term “forward”, when used in the context of the coupling ends of the first and second coupling members, is used relative to the longitudinally-extending channel whereby, the coupling end of the channel is referred to as the forward end and the opposing end of the channel is the rearward end.

The term “rearward” as used throughout the specification is thus used in opposition to the term “forward”. While the terms “forward” and “rearward” are used relative to each other, it is not envisaged that they necessarily require that the body of the coupling members include opposing forward and rearward ends. Rather, the terms are used to indicate the ends of the body of the first and second coupling members, which are provided with the openings for the channel, being at the connecting end and the coupling end.

The connecting end of the body of the coupling members can be any end to which fluid can be provided. In one non-limiting embodiment, the connecting ends of the bodies of the fluid line coupling members can be connected, or attached, to a hose. In some embodiments, a fluid line (such as a hose) may be formed integrally with the coupling members of the present invention. In this alternative embodiment, one end of the fluid line defines the forward coupling end and the other end defines the rearward connecting end. In another non-limiting embodiment of the present invention, the connecting end can be attached to, or integrally formed with, a fluid reservoir, such as a tank (for example as a tap, valve or faucet). In one embodiment, the connecting end of one or both coupling members is provided with a barb or screw thread for assisting in fixing the coupling members to a fluid source or fluid line.

The linear cam surface extends across at least a portion of the body of the first coupling member. In some embodiments, the linear cam surface traverses the body of the first coupling member, such that a leading end portion and trailing end portion of the linear cam surface extend to, or beyond, two opposing sides of the body of the first coupling member (e.g. an upper and lower side when oriented as described above). In some embodiments of the fluid line coupling, the linear cam surface is provided on two opposing lateral sides of the body of the first coupling member. In some embodiments, the linear cam surface is provided by at least one lateral projection from the body of the first coupling member. In some embodiments, there are two projections provided on opposing sides of the body of the first coupling member. These projections can be provided as separate surfaces, or may be linked by one or more bridging portion(s), to form a unified surface.

The linear cam surface may be provided by a collar that projects from the first coupling member to provide a planar surface intersected by the body of the first coupling member. In one orientation of this embodiment, the planar surface has two opposing side portions, an upper portion and a lower portion, with the upper portion positioned forward of the lower portion, such that the collar is diagonally inclined when viewed from the side of the coupling. In this embodiment, the upper portion is the leading portion of the linear cam surface, and the lower portion is the trailing portion. Consequently, movement of the follower from the upper portion of the collar toward the lower portion of the collar brings the coupling ends of the bodies of the first and second coupling members toward each other. In another orientation, the linear cam surface is vertically inclined when viewed from the side of the coupling. In this orientation, the upper portion of the linear cam surface is directly above the lower portion. As should be understood, the above orientations are merely used to provide a description of the relative positioning of the first coupling member in a specific orientation and do not require the first coupling member to be positioned in this specific orientation for operation.

The follower, provided on the second coupling member, can be any suitable structure that can operatively interact with the linear cam surface. In a preferred embodiment, the follower has at least a portion positioned forward of the coupling end of the second coupling member. Provision of a portion of the follower forward of coupling end of the second coupling member allows the follower to interact with the linear cam surface, provided on the body of the first coupling member, prior to engagement of the coupling ends of the first and second coupling members. Consequently, in this embodiment the entirety of the linear cam surface can be positioned rearward of the coupling end of the first coupling member.

In some alternative embodiments, the follower is positioned rearward of the coupling end of the second coupling member. In this embodiment, to facilitate cooperative interaction of the follower and the linear cam surface prior to engagement of the coupling ends of the two coupling members, at least the forward end of the linear cam surface will be positioned forward of the coupling end of the first coupling member.

The body of the second coupling member may include at least two followers positioned on opposing lateral sides of the body. In some embodiments, it is envisaged that the body of the first and second coupling members may be substantially provided by a cylinder, opposing sides would be considered as two sides divided by a bisecting longitudinal plane. The provision of at least two followers is preferable when the body of the first coupling member includes at least two linear cam surfaces.

While the follower can be any suitable structure that can operatively interact with the linear cam surface, in a preferred embodiment the follower is provided by a linear surface arranged to cooperatively interact with the linear cam surface of the first coupling member. In some forms of this embodiment, the linear surface of the follower abuts the linear cam surface of the first coupling member along at least a portion of its length, when the first and second coupling members are engaged. In some forms of this embodiment, both the linear cam surface of the first coupling member and the linear surface of the follower on the second coupling member, have a leading portion and a trailing portion. Cooperative interaction of the linear cam surface and the linear surface of the follower is effected by movement of the leading portions toward the trailing portions of both the linear cam surface and the follower. In further forms of this embodiment, both the linear cam surface of the first coupling member and the linear surface of the follower on the second coupling member have a leading portion positioned forward of the trailing portion.

In some embodiments, the follower is provided by a planar surface arranged to cooperatively interact with one or more linear cam surface(s) projecting from the body of the first coupling member. By providing a follower having a planar surface, the surface area provided to interact with the linear cam surface is maximised, and the structural rigidity of the follower is increased. In some embodiments, the follower is provided by a planar surface arranged to cooperatively interact with a collar projecting from the body of the first coupling member, and includes a cleft portion for positioning of the body of the first coupling member therein. The cleft portion provides a void in the planar surface that allows the positioning of the body of the first coupling member. As such, the planar surface of the follower may straddle the body of the first coupling member when the first and second coupling members are engaged. In some forms of this embodiment, the cleft includes a portion having a profile that substantially corresponds to at least a portion of the surface of the body of the first coupling member. For example, if the body of the first coupling member includes a curved outer surface, a portion of the cleft may include a corresponding curved portion.

The body of the first coupling member may further include a guide and the second coupling member includes a guide follower configured to operatively interact with the guide. In some embodiments, the guide in cooperation with the guide follower is provided to assist the positioning of the follower relative to the linear cam surface, thereby making engagement of the follower with the linear cam surface easier. In some embodiments, the guide and the guide follower assist in preventing the follower moving beyond the rearward end of the linear cam surface. In some embodiments, the guide is positioned forward of the linear cam surface.

In some embodiments, the guide may be provided by a linear surface. In some forms of this embodiment, the linear surface of the guide is angled to converge with the inclined linear cam surface. Consequently, the linear cam surface and the linear guide surface tend toward each other to form a general wedge-shape with a narrow end and a wide end. In some embodiments, the linear guide surface and the linear cam surface converge and include, or form, a vertex.

The angle of the linear guide surface can be any suitable angle, not parallel to the linear cam surface, such that it tends toward the linear cam surface at one end. In some embodiments, the angle between the linear cam surface and the linear guide surface is less than 45 degrees. In some embodiments, the angle between the linear cam surface and the linear guide surface is between 5 degrees and 25 degrees. In some embodiments, the angle between the linear cam surface and the linear guide surface is between 10 degrees and 15 degrees. In some embodiments, the angle between the linear cam surface and the linear guide surface is 12 degrees. In some embodiments, the linear guide surface mirrors the linear cam surface, wherein the axis of symmetry is perpendicular to the longitudinal axis of the channel.

In some embodiments, the linear guide surface is provided by the coupling end of the first coupling member.

In some embodiments, the guide is provided by at least one lateral projection from the body of the first coupling member. In some embodiments, the guide is provided on two opposing lateral sides of the body of the first coupling member. In some embodiments, the guide is provided by a collar that projects from the first coupling member to provide a planar surface intersected by the body of the first coupling member.

In some embodiments, the guide is provided by a planar surface intersected by the channel to form a coupling opening, wherein the planar surface provides the coupling end of the first coupling member.

In embodiments where the body of the first coupling member is provided with a guide surface, it may be advantageous for the guide follower to be conformed to the shape of the guide surface. Therefore, in some embodiments the guide follower is conformed to the shape of the guide surface.

In some embodiments, the guide follower includes the coupling end of the second coupling member. In some embodiments, the guide follower includes a lateral projection from the body of the second coupling member. In some embodiments, a guide is provided on two opposing lateral sides of the body of the first coupling member, hence, there are two guide followers provided on two opposing lateral sides of the body of the second coupling member.

In some embodiments, the guide follower includes a linear surface arranged to cooperatively interact with a guide of the first coupling member. In embodiments whereby the guide is provided by a linear surface, the linear surface of the guide follower is configured to substantially abut the linear surface of the linear guide, when the first and second coupling members are in sealed engagement.

The guide follower may be provided by a collar that projects from the second coupling member to provide a planar surface intersected by the body of the second coupling member. In some embodiments, the guide follower is provided by a planar surface intersected by the channel to form a coupling opening, wherein the planar surface provides the coupling end of the second coupling member.

In some embodiments, whereby the guide provides by the coupling end of the first coupling member, and the guide follower provides the coupling end of the second coupling member, the guide and guide follower are adapted to permit sealing engagement with each other.

The coupling end of the first and/or second coupling members may include a flexible portion, such as a washer, encircling the coupling opening(s) which assists in forming a sealed engagement.

In some embodiments, the guide follower includes a linear surface and the follower includes a linear surface, wherein the linear surface of the guide follower converges toward the follower at one end. In some embodiments, the linear surface is a planar surface. Consequently, the linear guide follower and the linear follower tends toward each other to form a general wedge-shape with a narrow end and a wide end. In some embodiments, the linear follower and the linear guide follower converge and include, or form, a vertex. The angle of the linear guide follower can be any suitable angle, not parallel to the linear follower, such that it tends toward the linear follower at one end.

In some embodiments, the angle between the guide follower and the follower is less than 45 degrees. In some embodiments, the angle between the guide follower and the follower is between 5 degrees and 25 degrees. In some embodiments, the angle between the guide follower and the follower is between 10 degrees and 15 degrees. In some embodiments, the angle between the guide follower and the follower is 12 degrees. In some forms of this embodiment, the follower and the guide follower are in a mirrored arrangement on the body of the second coupling member, wherein the axis of symmetry is perpendicular to the longitudinal axis of the channel.

In some forms of this embodiment, the linear surface of the guide follower and the linear surface of the follower converge to form, or includes, a vertex. In some forms of this embodiment, the linear surface of the guide follower and the linear surface of the follower converge at a vertex. In these forms, the linear surface of the guide follower and the linear surface of the follower form a general wedge-shape, with an opening at the wide end of the wedge-shape and a void provided between the linear surface of the follower and the linear surface of the guide follower.

In the above embodiment, the first and second coupling members can be coupled by positioning the upper, narrow, portion of the wedge-shape, provided by the linear cam surface and the linear guide surface on the first coupling member, into the opening at the wide end of the wedge-shape of the second coupling member. The second coupling member is then moved in a transverse direction relative to the first coupling member, to bring the longitudinally extending channels into axial alignment. This movement results in the follower on the second coupling member engaging the linear cam surface on the first coupling member, which assists in bringing the coupling ends of the two coupling members toward each other and into sealing engagement. Additionally, the guide and the guide follower may operatively interact, such that, at least when the coupling members are coupled, the guide surface and the guide follower are engaged. This may prevent further movement of the follower along the linear cam surface. In embodiments where the guide is provided by the coupling end of the first coupling member, and the guide follower is provided by the coupling end of the second coupling member, the interaction of the coupling ends of the first coupling member with the coupling end of the second coupling member, will prevent further movement of the follower along the linear cam surface.

As discussed above, one in use embodiment of the fluid line coupling of the present invention has the first coupling member set in an orientation such that the linear cam surface is inclined in a diagonal direction from the rearward connecting end of the body of the first coupling member upward toward the top, and forward toward the coupling end. The end of the linear cam surface closest to the coupling end is thus above the end of the linear cam surface closest to the connecting end. Further, the coupling end of the first coupling member is arranged to provide a face that converges (at least in part) with the linear cam surface.

As discussed above, one in use embodiment of the fluid line coupling of the present invention has the first coupling member set in an orientation such that the linear cam surface is inclined in a vertical direction. As such, the leading end of the linear cam surface is directly above the trailing end, and perpendicular to the longitudinal axis of the channel. Further, the coupling end of the first coupling member is arranged to provide a face that converges (at least in part) with the linear cam surface.

In the above particular in-use examples, the two coupling members can be engaged by positioning the opening at the wide end of the wedge-shape of the second coupling member above the vertex of the wedge-shape of the first coupling member. The second coupling member is then moved in a downward direction, such that the linear cam surface and the guide of the first coupling member are inserted into the void provided by the wedge-shape of the second coupling member. Further movement is then prevented by concurrent engagement of the follower with the linear cam surface and the guide follower with the guide. In the above embodiment, having the linear cam surface in a diagonal orientation, the linear cam surface vectors transverse movement to axial movement thereby bringing the two coupling members forward toward each other.

In some embodiments, the fluid line coupling includes an engageable locking mechanism which, when engaged, restricts at least the transverse movement of the first and second coupling members relative to each other when coupled. In some embodiments, the locking mechanism is provided on the first coupling member. In some embodiments, the locking mechanism is provided on the second coupling member. By restricting traverse movement, the locking mechanism acts to restrict movement of the first and second coupling in a direction, relative to each other, that facilitates uncoupling.

In embodiments where the second coupling member includes a guide follower having a linear surface and a follower has a converging linear surface which forms, or includes, a vertex, the first coupling member can include a locking mechanism which engages the vertex of the guide follower and the follower, thereby preventing transverse movement of the second coupling member. In a preferred embodiment, the locking mechanism includes a portion which abuts the vertex of the guide follower and the follower.

In some embodiments, the locking mechanism includes an arm which is anchored to the body of the first or second coupling member at a first end, the arm provided with an engaging portion on a second end, wherein the engaging portion is adapted to engage the opposing coupling member and limit the movement of the first and second coupling members relative to each other. In some embodiments that arm is resilient and allows movement of the engaging portion from a first locked position to a second unlocked position when a force is applied. In some embodiments, the resilient arm is anchored so that it biases the locking mechanism to a first, locked, position, but allows movement to a second unlocked position when a force is applied.

In some embodiments the portion of the locking mechanism adapted to engage the opposing coupling is a protrusion. In some embodiments, where the locking mechanism has an arm, the protrusion is approximately perpendicular to the arm. In a preferred form, the arm, including the protrusion or portion configured to interact with the second coupling member, interacts with the vertex of the converging linear follower and the linear guide follower.

In some embodiments, the locking mechanism is on the first coupling member. In some embodiments, the locking mechanism is pivotally mounted on the body of the first coupling member and can be moved from an unlocked position to a locked position, which, when the first and second coupling members are coupled, engages the second coupling member, and limits its transverse movement relative to the first coupling member. Preferably, the pivotally mounted locking mechanism includes a pivoting arm, the arm including a protrusion, or portion, configured to interact with the second coupling member. In a preferred form, the arm, including the protrusion or portion configured to interact with the second coupling member, interacts with the vertex of the converging linear follower and the linear guide follower.

In some embodiments, the locking mechanism is mounted on the body of the first or second coupling member and is movable from an unlocked position to a locked position which, when the first and second coupling members are coupled, engages the counterpart coupling member and limits transverse movement of the first and second coupling members relative to each other. In some embodiments, the locking mechanism is slidable from a first locked position to a second unlocked position. In some embodiments, the locking mechanism slides in a longitudinal directions relative to the body of the first or second coupling connector.

In some embodiments the locking mechanism is biased and allow movement from a resting first locked position, to a second unlocked position when a force is applied, then returns to the first position when the force is removed. In some embodiments the locking mechanism is biased by a resilient member (such as a resilient arm) which is anchored at one end to allow movement from a resting first locked position, to a second unlocked position when a force is applied. Alternative biasing means are known in the art and include any mechanism that urges the locking mechanism to a predetermined position, such as a coil spring or elastic member.

In some embodiments, the locking mechanism is on the second coupling member and protrudes into the void between the follower and a guide and/or or the coupling end, of the second coupling member. In this embodiment, the locking mechanism can be moved from a first locked position protruding into the void, into a second unlocked position, which permits engagement of the first and second coupling members. The locking mechanism can then be moved back to the first position to restrict transverse movement of the first and second coupling members, relative to each other.

In some embodiments, the locking mechanism is moved from its first position to the second position by moving the first and second coupling members relative to each other in a direction to facilitate sealing engagement. In some embodiments, the locking mechanism includes a ramp surface that interacts with a counterpart coupling, during engagement of the first and second coupling members, to move the locking mechanism from the first, resting, position to the second position. The locking mechanism then returns to the first position when the first and second couplings are in sealable engagement. In some embodiments, one of the two couplings includes a recess for receiving the locking mechanism. In some embodiments, the locking mechanism engages an outer surface of the first or second coupling members.

While the above describes the invention by way of particularly envisaged embodiments in isolation, it is to be understood by those persons skilled in the art that these embodiments are not exclusive and can be combined.

### BRIEF DESCRIPTION OF DRAWINGS

Having briefly described the general concepts involved with the present invention, preferred embodiments of a fluid line coupling will now be described that is in accordance with the present invention. However, it is to be understood that the following description is not to limit the generality of the above description.

FIG. 1 illustrates a side view of an embodiment of a first coupling member of a fluid line coupling having a diagonally inclined linear cam surface in accordance with the present invention;

FIG. 2 illustrates a side view of an embodiment of a first coupling member of a fluid line coupling having a vertically inclined linear cam surface in accordance with the present invention;

FIG. 3 illustrates a side view of an embodiment of a second coupling member of a fluid line coupling having a diagonally inclined linear follower surface in accordance with the present invention;

FIG. 4 illustrates a side view of an embodiment of a second coupling member of a fluid line coupling having a vertically inclined linear follower surface in accordance with the present invention;

FIG. 5 illustrates a three-dimensional view of the embodiment of the first coupling member of FIG. 1;

FIG. 6 illustrates a three-dimensional view of the embodiment of the first coupling member of FIG. 2;

FIG. 7 illustrates a three-dimensional view of an embodiment of the second coupling member of FIG. 3;

FIG. 8 illustrates a three-dimensional view of an embodiment of the second coupling member of FIG. 4;

FIG. 9 illustrates a top view of the embodiment of the first coupling member FIG. 1;

FIG. 10 illustrates a top view of the embodiment of the first coupling member of FIG. 2;

FIG. 11 illustrates a bottom view of the embodiment of the second coupling member of FIG. 3;

FIG. 12 illustrates a bottom view of the embodiment of the second coupling member of FIG. 4;

FIG. 13 illustrates a three-dimensional view of an embodiment of the first and second coupling members disengaged;

FIG. 14 illustrates the reverse three dimensional view of FIG. 13;

FIG. 15 illustrates an exploded view of an embodiment of the second coupling member in combination with a hose retention member and a locking nut;

FIG. 16 illustrates a side view of an embodiment of the first and second coupling members of FIGS. 1 and 3 in sealed engagement;

FIG. 17 illustrates a side view of an embodiment of the first and second coupling members FIGS. 2 and 4 in sealed engagement;

FIG. 18 illustrates a side view of an embodiment of the fluid line coupling connected to a tap;

FIG. 19 illustrates a side view of an embodiment of a first coupling member of a fluid line coupling in accordance with the present invention for connection to a tap as illustrated in FIG. 18;

FIG. 20 illustrates a three-dimensional view of the first coupling member of FIG. 19;

FIG. 21 illustrates a front view of an embodiment of a second coupling member of a fluid line coupling in accordance with the present invention for connection to the first coupling member of FIG. 18;

FIG. 22 illustrates a three-dimensional view of the second coupling member of FIG. 21;

FIG. 23 illustrates a top view of a one-way male first coupling member;

FIG. 24 illustrates a top view of a two-way male first coupling member;

FIG. 25 illustrates a top view of a three-way male first coupling member;

FIG. 26 illustrates a top view of a four-way male first coupling member;

FIG. 27 illustrates a top view of a double ended male elbow first coupling member;

FIG. 28 illustrates a three-dimensional view of an embodiment of a fluid line coupling in accordance with the present invention for high pressure uses;

FIG. 29 illustrates a reverse three-dimensional view of FIG. 28;

FIG. 30 illustrates a three-dimensional view of a multi-channel embodiment of a fluid line coupling in accordance with the present invention;

FIG. 31 illustrates a reverse three-dimensional view of FIG. 30;

FIG. 32 illustrates a side view of embodiments of the first and second coupling members in accordance with the present invention, in sealed engagement;

FIG. 33 illustrates a side view of embodiments of the first and second coupling members in accordance with the present invention, in sealed engagement;

FIG. 34 illustrates a side view of embodiments of the first and second coupling members in accordance with the present invention, in sealed engagement;

FIG. 35 illustrates a side view of embodiments of the first and second coupling members in accordance with the present invention, in sealed engagement; and

FIG. 36 illustrates a side view of embodiments of the first and second coupling members in accordance with the present invention, in sealed engagement.

### DETAILED DESCRIPTION

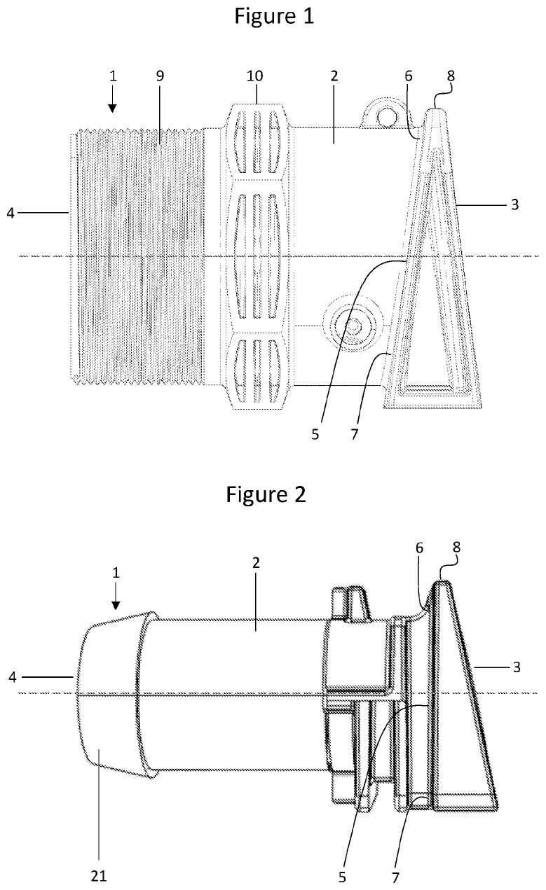

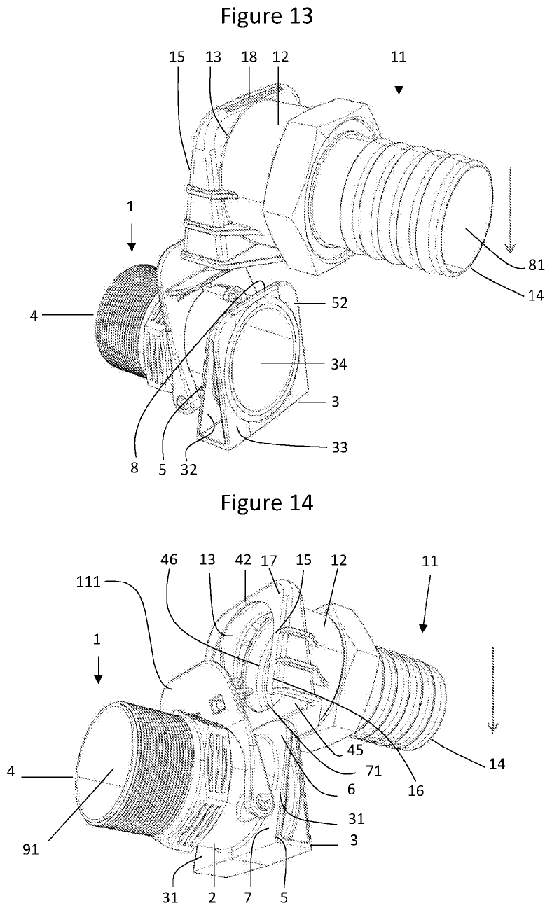

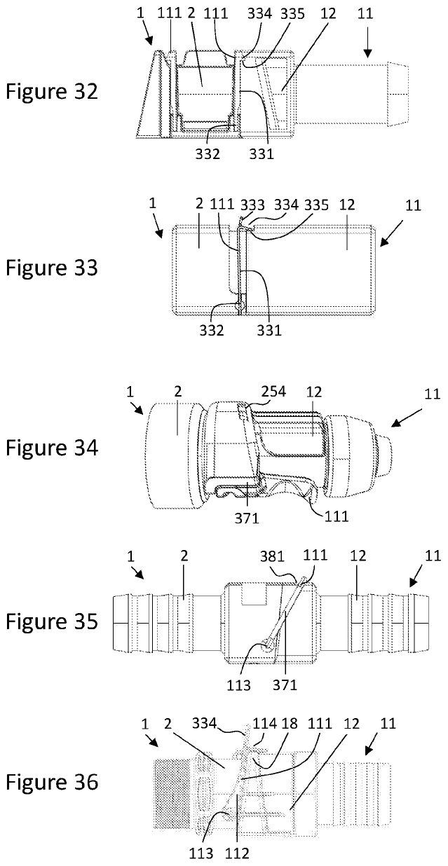

The first and second coupling members of the fluid line coupling are illustrated in FIGS. 1 to 12, 15, 19 to 27, in isolation. FIGS. 13, 14, 16 to 18 and 28 to 31 illustrate the operative interaction of the first and second coupling members in a preferred ‘in use’ orientation. FIGS. 32 to 36 illustrate embodiments of various locking mechanisms for use with the fluid line coupling of the present invention

FIG. 1 illustrates a preferred embodiment of the first coupling member (1) including a body (2) having a forward coupling end (3) and a rearward connecting end (4). The body includes a longitudinally-extending channel (not shown) passing therethrough to permit the flow of fluid from the connecting (4) end to the coupling end (3).

The body (2) of the first coupling member includes a linear cam surface (5) inclined in a diagonal direction relative to the longitudinal axis of the channel (indicated by the dashed line). The linear cam surface has a leading portion (6) at the forward end of the linear cam surface (5), and a trailing portion (7) at the rearward end of the linear cam surface (5). The first coupling member (1) also includes a linear guide surface that, in the illustrated embodiment, is provided by the coupling end (3).

FIG. 2, illustrates an additional embodiment of the first coupling member of the present invention having the linear cam surface (5) inclined in a direction perpendicular to the longitudinal axis of the channel (indicated by the dashed lines).

While the illustrated embodiments of the first coupling member (1) are illustrated with the guide surface being provided at, and by, the coupling end (3), it is envisaged that the guide may be provided forward or rearward of the coupling end (3). Likewise, the linear cam surface (5) is illustrated as being positioned wholly rearward of the coupling end (3) of the body (2) of the first coupling member (1). However, it is envisaged that the linear cam surface (5) may be positioned partially, or in some embodiments entirely, forward of the coupling end (3).

As can be seen in FIG. 1, the linear cam surface (5) and the linear guide surface (3) are arranged in a mirrored arrangement, with the axis of symmetry (not shown) perpendicular to the longitudinal axis of the of the channel (indicated by the dashed lines) such that the decline of linear guide surface (3) is opposite to the incline of the linear cam surface (5). Noting that the term “decline” in the context of the first coupling member of FIG. 1 refers to a diagonal decline in the left to right direction as illustrated in FIG. 1 (i.e. from the rearward end to the forward end of the first coupling member).

In the illustrated embodiments of FIG. 1 and FIG. 2, the inclined linear cam surface (5) and the declined linear guide surface (3) meet at a vertex (8).

While the linear cam surface (5) and the linear guide surface (3) of the illustrated embodiment are illustrated as linear surfaces, it is envisaged that the guide (3) is not limited to linear surfaces. Further, in instances whereby the guide (3) is provided by a linear surface, it is not necessary for it to be in a mirrored configuration to the linear cam surface (5). Rather, the linear guide surface (3) and the linear cam surface (5) should be configured such that they tend toward each other at one end. In the embodiments illustrated in FIGS. 1 and 2, the internal angle between the linear cam surface (5), and the linear guide surface (3), is 12 degrees, although other angles of convergence are envisaged.

In the embodiment illustrated in FIG. 1, where the linear cam surface (5) is provided by a diagonally inclined surface, the angle of the linear cam surface (5) is 6 degrees relative to vertical, or 84 degrees relative to the longitudinal axis of the channel (dashed line). In embodiments where the linear cam surface (5) and the linear guide surface (3) are provided in a mirrored arrangement, the linear guide surface (3) will have an identical, but opposing angle.

In the embodiment illustrated in FIG. 2, wherein the linear cam surface (5) is inclined perpendicular to the longitudinal axis of the channel, the linear guide surface (3) is diagonally declining at 12 degrees relative to the linear cam surface (5).

While the above are preferred angles, other angles of inclination, declination and convergence are envisaged. In some embodiments, the angle of inclination of the linear cam surface (5) is between 0 degrees and 12 degrees, relative to vertical, 90 degrees to 78 degrees relative to the longitudinal axis of the channel (dashed lines). In some embodiments, the angle of declination of the linear guide surface (3) is between 0 degrees and −12 degrees relative to the vertical, or 90 degrees to −78 degrees relative to the longitudinal axis of the channel, on the proviso that the linear cam surface (5) and the linear guide surface (3) tend toward each other at a leading portion (6) of the linear cam surface.

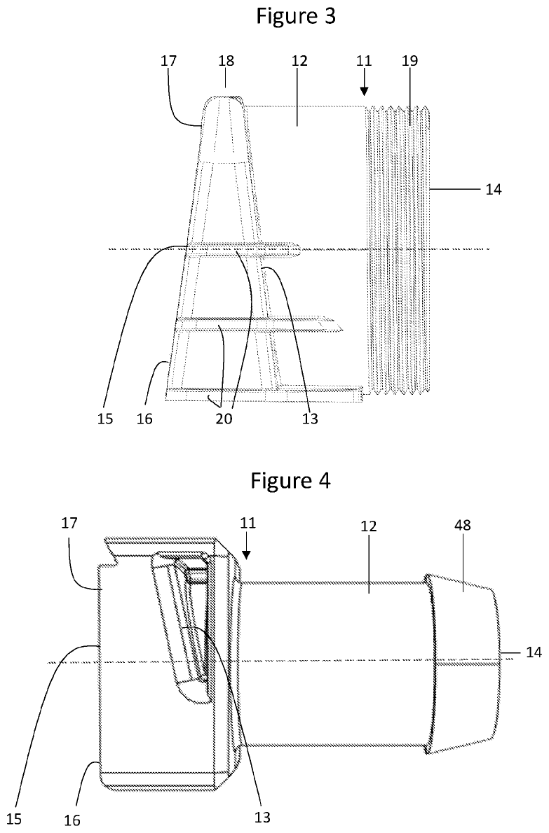

Further, the guide (3) of the first coupling member (1) is provided by a linear surface in the illustrated embodiment. However, as discussed above, it is envisaged that the guide (3) can be provided by any suitable structure which acts to engage, and guide, the placement and engagement of the second coupling member (11—see FIG. 3) with the first coupling member (1). For example, the guide (3) may be provided by a forward or sideways protrusion(s) from the body (2) of the first coupling member (1). Alternatively, the guide (3) may be a curved face, or only a portion of the guide (3) may be angled to converge with the linear cam surface (5).

In the illustrated embodiment of FIG. 1, the body (2) of the first coupling member (1) is provided with a male screw thread (9) near the connecting end (4) for engagement with a corresponding female screw thread of a fluid line, or fluid reservoir, such as a tank. Also provided is a hexagonal protrusion (10) adapted to be gripped to provide torsion to the first coupling member (1) to assist in engagement of the male screw thread (9) with a reciprocal thread. Specifically, the hexagonal protrusion (10) is adapted to be received by a spanner or wrench to facilitate torsion of the first coupling member (1). However, other structures are envisaged to be provided on the first coupling member (1) to facilitate torsion.

FIG. 2 illustrates an alternative retention means for retain a fluid line (not shown) in connection with the coupling. In the illustrated embodiment of FIG. 2, the body (2) of the first coupling member (1) is provided with a radial protrusion (21) near the connecting end (4). The radial protrusion (21) has a perpendicular forward face and a diagonally inclined rearward face. The diagonally inclined rearward face of the radial protrusions (21) assist in positioning a hose (not shown) over the radial protrusion (21) and the forward perpendicular face help prevent the hose from disconnecting from the coupling (1). Once positioned over the connecting end (4) of the coupling (1), a hose clamp, or similar retention device, can be used to secure the hose to the coupling.

While the embodiments of FIGS. 1 and 2 are provided with a male screw thread (9), or radial protrusion (21), for connecting to a fluid line, or reservoir, the first coupling member can be connected to a fluid line, or fluid reservoir in any desired manner. For example, the coupling member could include a female screw thread, or alternatively could be integrated into, or formed integrally with, a fluid line or a fluid reservoir thereby providing the outlet or inlet for the fluid reservoir. Additional means of connecting the connecting end (4) of the first coupling member (1) to a fluid line, fluid reservoir or the like are known in the art and are envisaged as being suitable for use with the present fluid line coupling.

FIG. 3 illustrates an embodiment of the second coupling member (11) (for engagement with the first coupling member of FIG. 1) including a body (12) having a forward coupling end (13) and a rearward connecting end (14). FIG. 4 illustrates an embodiment of the second coupling member (11) (for engagement with the first coupling member of FIG. 2) including a body (12) having a forward coupling end (13) and a rearward connecting end (14). For brevity, the coupling members of FIGS. 3 and 4 will be referred to below in the singular as “second coupling member”.

The body of the second coupling member includes a linear follower (15) adapted to interact with the linear cam surface (5) of the first coupling member (1). The linear follower (15) has a leading portion (16) at the forward end of the linear follower (15), and a trailing portion (17) at the rearward end of the linear follower (15). The second coupling member (11) also includes a linear guide follower, which in the illustrated embodiments, is provided by the coupling end (13) of the second coupling member (11).

In the embodiment illustrated in FIGS. 1 to 4, the follower (15) of the second coupling member (11) is positioned forward of the coupling end (13) and is adapted to engage the linear cam surface (5) of the first coupling member (1). The positioning of the follower (15) relative to the coupling end (13) is dependent on the positioning of the linear cam surface (5) provided on the body (2) of the first coupling member (1). In embodiments where the linear cam surface (5) is provided entirely rearward of the coupling end (3) of the body (2) of the first coupling member (1), then the follower (15) is provided entirely forward of the coupling end (13) of the body (12) of the second coupling member (11).

However, in envisaged embodiments, whereby at least a portion of the linear cam surface (5) is provided forward of the coupling end (3) of the body (2) of the first coupling member (1), then at least a portion of the follower (15), provided on the body (12) of the second coupling member (11), may be positioned rearward of the coupling end (13) of the body (12) of the second coupling member (11).

As can be seen in FIG. 3, the linear follower (15) and the linear guide follower (13) are arranged in a mirrored arrangement, with the axis of symmetry perpendicular to the longitudinal axis of the channel (dashed line) such that the diagonal incline of linear follower (15) is opposite to the diagonal decline of the guide follower (13), noting that the term “incline” in the context of the embodiment of the second coupling member illustrated in FIG. 3 refers to an diagonal incline in a left to right direction as illustrated, i.e. from the forward end to the rearward end. In the illustrated embodiment, the linear follower (15) and the linear guide follower (13) converge toward each other at an internal angel of 12 degrees and meet at a vertex (18).

The linear follower (15) illustrated in FIG. 4 is arranged such that it is inclined perpendicular to the longitudinal axis of the channel (dashed line). In the embodiment illustrated in FIG. 4, the linear guide follower (13) is diagonally declined (relative to the longitudinal axis of the channel) and converges with the linear guide follower (15) at an internal angle of 12 degrees, with the two tending toward each other, but not meeting (see FIG. 8).

Further, the follower (15) of the second coupling member (11) is provided by a linear surface in the illustrated embodiment, However, it is envisaged that the follower (15) can be provided by any suitable structure which acts to engage the linear cam surface (5) of the first coupling member (1). For example, the follower (15) may be provided by a forwardly positioned, inwardly facing, protrusion(s).

In the embodiment illustrated in FIG. 3 the body (12) of the second coupling member (11) is provided with a male screw thread (19) near the connecting end (14) for engagement with a corresponding female screw thread of a fluid line, or fluid reservoir such as a tank. While the preferred embodiment is provided with a male screw thread (19) for connection, the second coupling member can be connected to a fluid line, or fluid reservoir in any desired manner. For example, the coupling member could include a female screw thread, or alternatively could be integrated into, or formed integrally with, a fluid line or a fluid reservoir. Additional means of connecting the connecting end (14) of the second coupling member (11) to a fluid line, fluid reservoir or the like are known in the art and are envisaged as being suitable for use with the present fluid line coupling.

FIG. 4 illustrates an alternative retention means for retain a fluid line (not shown) in connection with the second coupling member. In the illustrated embodiment of FIG. 4, the body (12) of the second coupling member (11) is provided with a radial protrusion (48) near the connecting end (14). The radial protrusion (48) has a perpendicular forward face and a diagonally declining rearward face. The diagonally declining rearward face of the radial protrusions (48) assist in positioning a hose (not shown) over the radial protrusion (48) and the forward perpendicular face help prevent the hose from disconnecting from the coupling (11). Once positioned over the connecting end (14) of the body (11), a hose clamp, or similar retention device, can be used to secure the hose to the coupling.

The second coupling member (11) illustrated in FIG. 3, includes support ridges (20) which bridge from the body (12) to the linear follower (15). The support ridges (20) are provided to increase the structural integrity of the linear follower (15) and prevent flexing in the forward direction. This additional support may help to prevent breakage of the linear follower (15) away from the body (12) of the second coupling member (11).

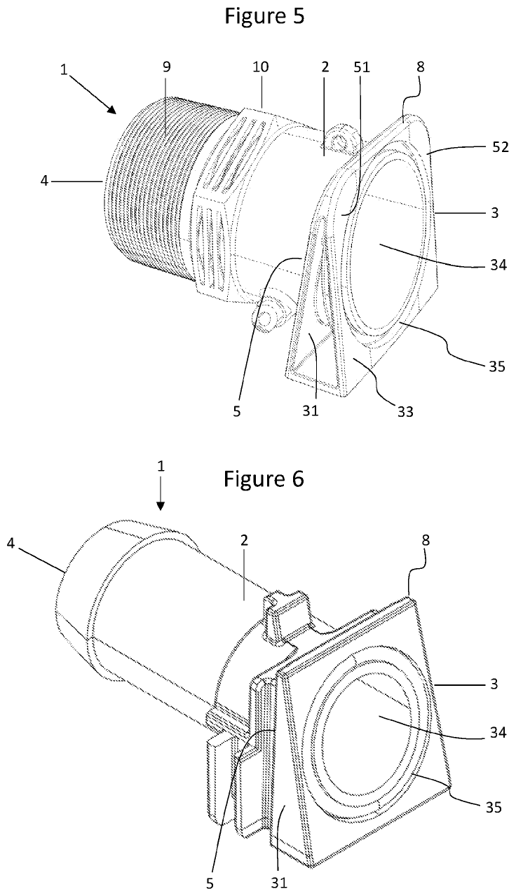

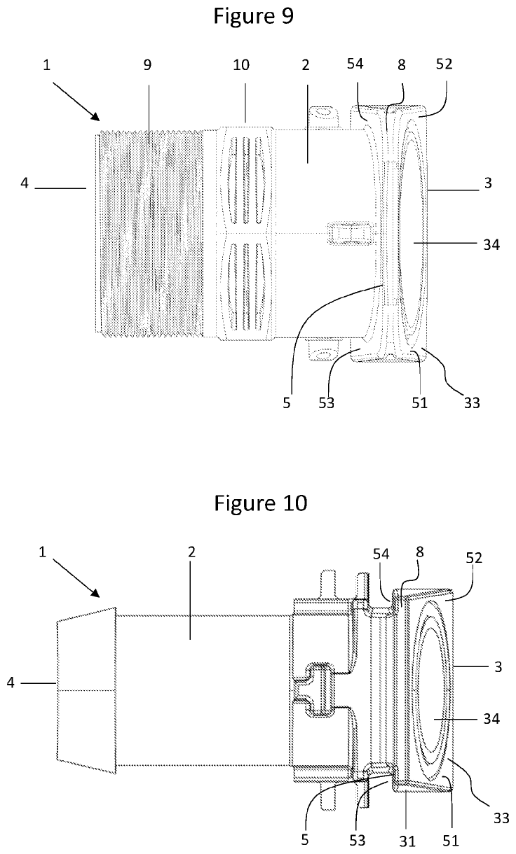

FIG. 5 illustrates a three-dimensional view of the embodiment of the first coupling member (1) illustrated in FIG. 1, and FIG. 6 illustrates a perspective view of the embodiment illustrated in FIG. 2. As can be seen in FIGS. 5 and 6, the linear cam surface (5) is provided by a collar (31) that projects from the body (2) of the first coupling member (1) to provide a planar surface intersected by the body (2) of the first coupling member (1). Consequently, the collar (31) provides a linear cam surface (5) on two opposing lateral sides of the first coupling member (1). Specifically, the collar (31) provides at least two projections (53 and 54—see FIGS. 9 and 10) which laterally project from the sides of the body (2) of the first coupling member (1). The coupling end (3) of FIG. 5 also includes a further collar (33) which provides a guide surface for the first coupling member (1). In the illustrated embodiments, the collar (33) providing the guide surface also provides the coupling end (3) of the first coupling member (1) and is positioned forward of the linear cam surface (5). However, in the embodiment illustrated in FIG. 6, the guide surface of the first coupling member (1) is the side of the collar (31) opposing the linear cam surface (5).

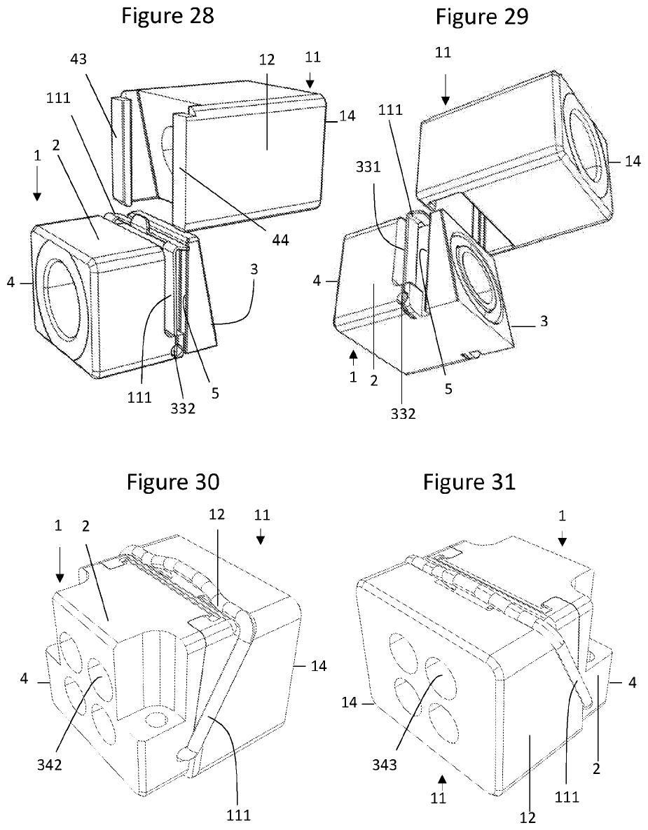

While the linear cam surface (5) of the first coupling member (1) illustrated in FIGS. 1, 2, 5 and 6 includes a projecting collar which provides two laterally extending protrusions (53 and 54), it is envisaged that the linear cam surface (5) can be provided by any suitable structure. For example, FIGS. 28 and 29 illustrate the linear cam surface (5) as being provided by two laterally positioned grooves that are inclined across the body (2) of the first coupling member (1). Alternatively, the linear cam surface (5) may be provided by one or more bores, which extend from the top of the body (2) of the first coupling member (1) and extend in a downward and rearward direction toward the bottom of the body (2). In such embodiments, the follower (15) provided on the body (12) of the second coupling member (11) will be adapted to conform with the linear cam surface (5).

Additionally, while the guide (3) of the first coupling member (1) illustrated in FIGS. 1, 2, 5 and 6 includes a projecting collar (33) which provides two laterally extending protrusions (51 and 52—see FIG. 9), it is envisaged that the guide (3) can be provided by any suitable structure. For example, the guide (3) may be provided by one or more grooves the are inclined in a traverse direction across at least a portion of the body (2) of the first coupling member (1). Alternatively, the guide (3) may be provided by one or more bores (not shown), which extend from the top of the body (2) of the first coupling member (1) and extend in a downward and rearward direction toward the bottom of the body (2). In such embodiments, the guide follower (13) provided on the body (12) of the second coupling member (11) will be adapted to conform with the guide (3).

The coupling end (3) of the body (2) of the first coupling member (1) is illustrated with an annular groove (35) adapted for positioning of a flexible sealing member (not shown), such as an annular rubber washer, to assist in forming a seal with the coupling end (13) of the body (12) of the second coupling member (11).

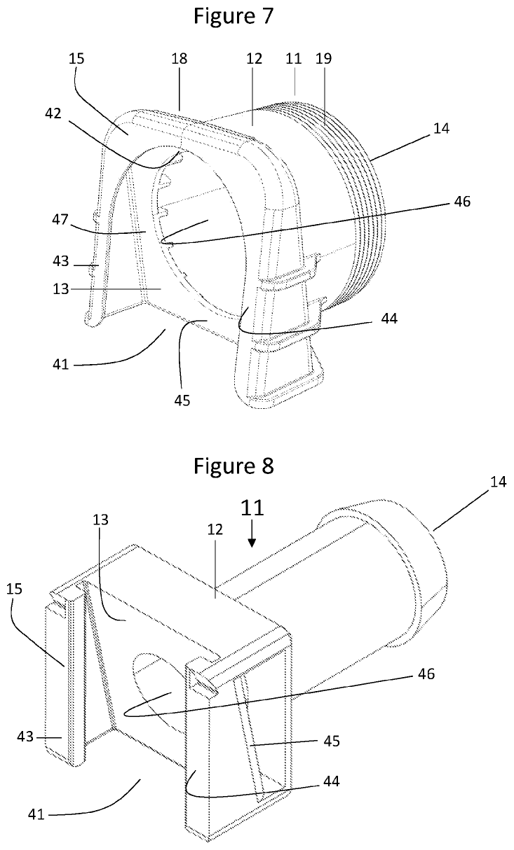

FIGS. 7 and 8 illustrate three-dimensional views of preferred embodiments of the second coupling member (11). As can be seen, the follower (15) is provided by a linear surface arranged to cooperatively interact with the collar (31) projecting from the first coupling member. The planar surface of the follower (15) includes a cleft portion (41), for positioning of the body (2) of the first coupling member (1) therein. The cleft of FIG. 7 includes a portion (42) having a profile that substantially corresponds to at least a portion of the surface of the body (2) of the first coupling member (1). In the embodiments illustrated in FIGS. 1 and 5, the body (2) of the first coupling member (1) is provided by a cylinder and therefore the profile of the portion (42) of the cleft (41) illustrated in FIG. 7 has a curved profile to abut the surface of the cylindrical body (2) of the first coupling member (1).

The follower illustrated in FIGS. 7 and 8 is provided by two projections (43 and 44) positioned on opposing lateral sides relative to the body (12) of the second coupling member (11). These two linear projections (43 and 44) are adapted to cooperatively interact with the two linear projections (53 and 54) provided on the body (2) of the first coupling member (1). The followers in FIG. 7 are connected via a bridge portion to form a generally planar follower having a cleft (41)

Additionally illustrated in FIGS. 7 and 8 is the coupling end (13) of the body (12) of the second coupling member (11). The coupling end (13) also includes a collar (45) laterally projecting from the body (12) of the second coupling member (11). The collar (45) provides a planar guide follower for the second coupling member (11). In this embodiment, the collar (45) providing the guide follower also provides the coupling end (13) of the second coupling member (11) and is positioned rearward of the followers (43 and 44). The guide follower (45/13) is configured to operatively interact with the guide (33) of the first coupling member (1). As the collar (45) provides the coupling end (13) for the body (12) of the second coupling member (11), the planar surface of the collar (45) is intersected by the body (12) of the second coupling member (11), and the channel therethrough, to provide a coupling opening (46). Further, the collar (45), projecting from the body (12) of the second coupling member (11), provides two laterally projecting linear guide followers (47 and 78—see FIG. 12).

The relative arrangement of the follower (15) and the guide follower (13/45) of the second coupling member provides a void for positioning of the linear cam surface (5—see FIGS. 1, 2 5, 6, 9 and 10) and the guide (3/33—see FIGS. 5 and 6) of the first coupling member (1).

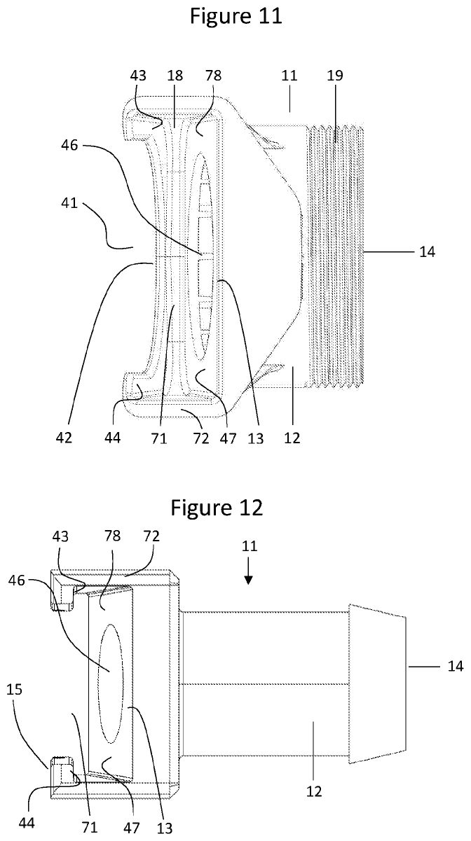

FIGS. 9 and 10 illustrate top views of the first coupling member (1) of FIGS. 1 and 2. As can be seen, the collar (33 in FIGS. 9 and 31 in FIG. 10) provides the coupling end (3/33) of the first coupling member (1), and defines a planar surface, which is intersected by the body (2) of the first coupling member (1). Consequently, the channel provided through the body (2) of the first coupling member (1) intersects the collar (3/33) to provide a coupling opening (34). The coupling opening (34) at the coupling end (3) of the body (2) of the first coupling member (1) is configured to be in fluid communication with the coupling opening (46) of the second coupling member (11), when the coupling members are engaged, thereby permitting fluid to flow from the channel of the first coupling member (1) to the channel of the second coupling member (2). Further, the collar (3/33) projecting from the body (2) of the first coupling member (1) provides two laterally projecting linear guide surfaces (51 and 52) that are configured to cooperatively interact with the two laterally projecting guide followers (47 and 78—see FIGS. 11 and 12) provided on the body (12) of the second coupling member (11).

FIGS. 11 and 12 illustrate bottom views of embodiments of the second coupling member (11) in accordance with the present invention. The collar (45), providing the guide follower, also provides the coupling end (13) of the second coupling member (11) and is positioned rearward of the follower (15). The guide follower (13/45) is configured to operatively interact with the guide (3/33) of the first coupling member (1). As the collar (45) provides the coupling end (13) for the body (12) of the second coupling member (11), the planar surface of the collar (45) is intersected by the body (12) of the second coupling member (11), and the channel provided therethrough, to provide a coupling opening (46). Further, the collar (45) projecting from the body (12) of the second coupling member (11) provides two laterally projecting linear guide followers (47 and 78).

The inclined follower (15), in cooperation with the lateral projections (47 and 78) providing the diagonally declining guide follower, form a general wedge-shape with a wide portion providing and opening (71) for placement of the linear cam surface (5) and the guide (3/33) of the first coupling member (1). Webbing (72) links the guide follower (13/45) to the follower (15) on both sides of the second coupling member to assist in preventing movement of the follower (15) away from the body (12) of the second coupling member (11).

FIGS. 13 and 14 illustrate the operation of an embodiment of the fluid line coupling of the present invention. In a preferred orientation, the first coupling member (1) is positioned, or fixed, such that the vertex (8) is pointing in an upward direction. The second coupling member (11) is positioned above the first coupling member (1) such that the void (71) provided between the follower (15) and the guide follower (13/45), which defines the coupling end (13), is positioned above the vertex (8) of the first coupling member (1). The second coupling member (11) is then moved in a traverse direction (as indicated by the arrow) over the linear cam surface (5) and a collar (33) providing a linear guide surface, which defines the coupling end (3) of the first coupling member (1). This movement engages the leading portion (16) of the follower (15) with the leading portion (6) of the linear cam surface (5). Movement of the follower (15) along the linear cam surface (5), toward the trailing portion (7), brings the coupling ends (3 and 13) of the first and second coupling members (1 and 11) into sealed engagement, and the coupling openings (46 and 34) into fluid engagement. Fluid can then pass from the connecting end (4) of the first coupling member through the channel (91) provided through the body (2) of the first coupling member (1) and into the channel (81) provided through the body (12) of the second coupling member (11) and to the connecting end (14) of the second coupling member (11).

The open wedge-shape provided between the follower (15) and the guide follower (13/45) of the second coupling member (11) helps locate the vertex (8) of the first coupling member (1). Resultantly, a user does not need to accurately position the second coupling member (11) above the first coupling member (1), as the wedge-shape provided by the linear cam surface (5) and the linear guide surface (3/33) of the first coupling member (1) will position the second coupling member (11). Therefore, the fluid line coupling of the present invention does not require a large degree of dexterity.

Operation of the embodiment of the invention disclosed in FIGS. 13 and 14 causes longitudinal movement of the second coupling member (11) (and any attachments, such as a pipe) relative to the first coupling member (1) as the follower (15) moves along the linear cam surface (5). However, when the embodiment of the first (1) and second (11) coupling members illustrated in FIGS. 2, 4, 6, 8, 10 and 12 are brought into engagement in the manner illustrated in FIGS. 13 and 14, the second coupling member (11) does not need to move longitudinally during coupling, due to the perpendicular orientation of the linear cam surface (5). Therefore, advantageously, in instances when fitting a pipe which cannot change in length (for example an inflexible metal pipe in a point-to-point connection) the perpendicular nature of the linear cam surface (5) (relative to the longitudinal axis of the channel) allows easy fitting.

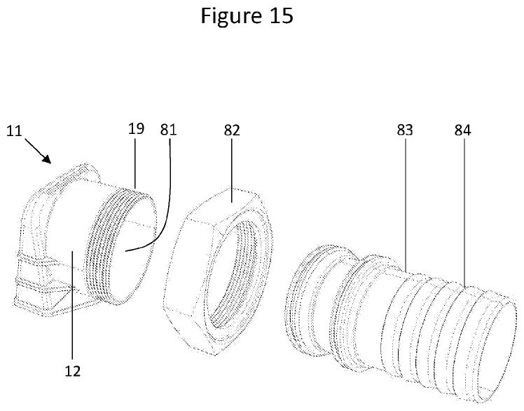

FIG. 15 provides an exploded view of an embodiment of the second coupling member (11). The second coupling member (11) illustrated in FIG. 15 includes an example of a hose connection means including a hexagonal locking nut (82), and a hose retention member (83). The hose retention member (83) is provided with a series of radial protrusions (84) having a perpendicular forward face and a diagonally declining rearward face. The locking nut (82) in cooperation with the hose retention member (83), act to retain a hose (not shown) in cooperation with the second coupling member the components are assembled by placing the hose retention member (83) into the channel (81) of the second coupling member (11) before the locking nut (82) is brought into engagement with the screw thread (19) provided on the body (12) of the second coupling member (11). Rotation of the locking nut (82) secures the hose retention member (83) in the channel (81) of the second coupling member (11). Subsequently, the hose retention member (83) is positioned within the channel of a hose. The diagonally declining rearward face of the radial protrusions (84) assist in positioning the hose over the hose retention member (83) and the forward perpendicular faces help prevent the hose from disconnecting from the hose retention member (83).

Once secured in the channel (81) of the second coupling member (11), the hose retention member (83) can rotate within the channel, thereby permitting axial rotation of the second coupling member (11) relative to the hose retention member (83) and any connected hose (not shown). This is particularly useful when using large hoses (such as 6-inch hoses) which have little flexibility, and permits easy orientation of the second coupling member (11) for engagement with the first coupling member (1).

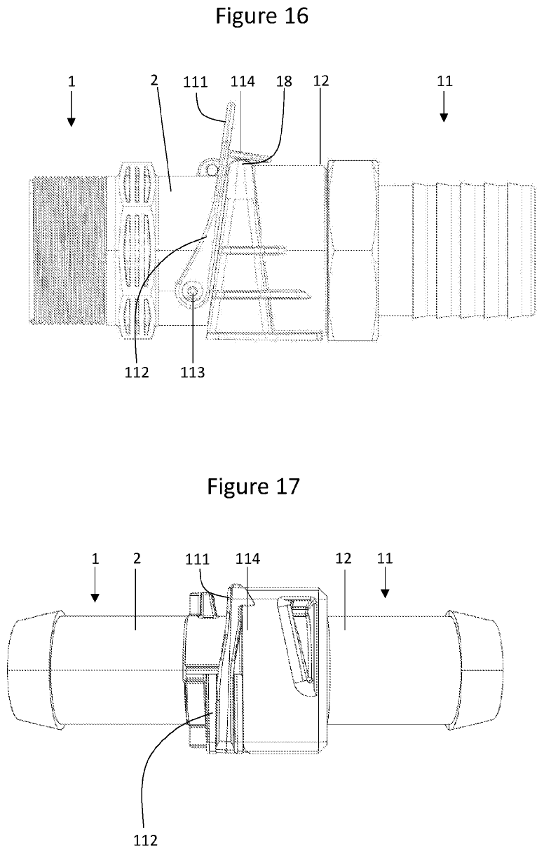

FIGS. 16 and 17 illustrate the engagement of the first (1) and second (11) coupling members. As can be seen, the bodies (2 and 12) of the first (1) and second (11) coupling members have been brought into axial alignment. In this alignment, the coupling openings (not visible in FIGS. 16 and 17) have been brought into fluid communication, and the coupling ends (not visible in FIGS. 16 and 17) of the first (1) and second (11) coupling members are in sealing engagement.

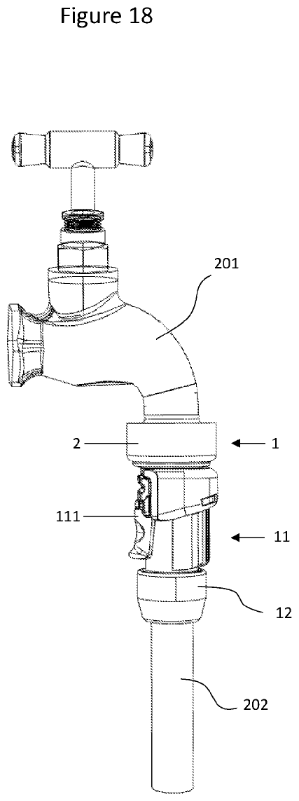

FIG. 18 illustrates a further embodiment of the present invention specifically adapted to permit the quick connection of a tap (201) to a fluid line (202). The first coupling member (1) is connected to the tap (201) via a thread (not shown). Standard thread forms are known in the art and may vary from country to country and depending on the application. For example, external taps and hoses utilise British Standard Pipe (BSP) in commonwealth countries such as Australia and the UK, while Garden Hose Thread (GHT) is common in the US. In the embodiment illustrated in FIG. 18, the fluid line (202) is connected to the second coupling member (11), which is in sealed engagement with the first coupling member (1). The fluid line (202) is retained in connection with the second coupling member (11) via a locking nut (82) which screws onto a thread (not shown) on the second coupling member (11). The second coupling member includes a locking mechanism (111) which can be released to allow disengagement of the second coupling member (11) from the first coupling member (1).

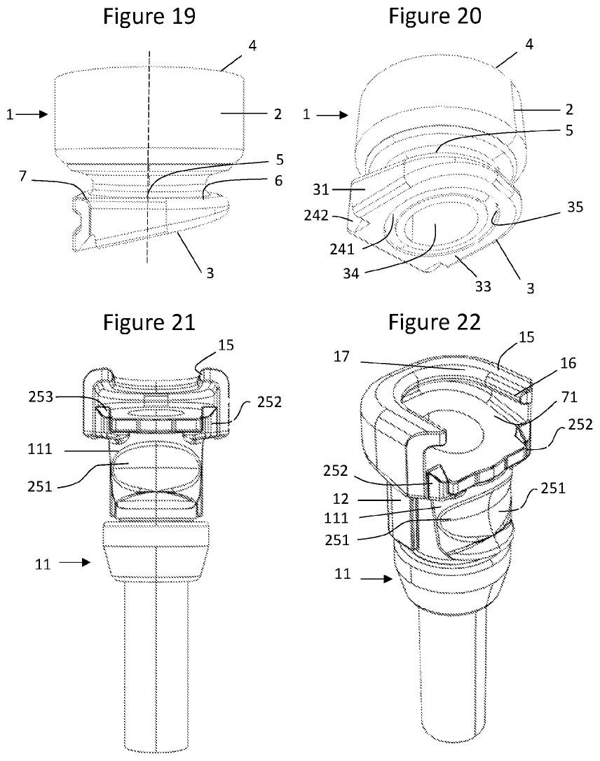

FIG. 19 illustrates a side view of an embodiment of the first coupling member (1) as illustrated in FIG. 18 and adapted for attachment to a tap. The first coupling member (1) includes a body (2) having a forward coupling end (3) and a rearward connecting end (4). The body includes a longitudinally-extending channel (not shown) passing therethrough to permit the flow of fluid from the connecting (4) end to the coupling end (3).

The body (2) of the first coupling member includes a linear cam surface (5) inclined relative to the longitudinal axis of the channel (indicated by the dashed line). The linear cam surface has a leading portion (6) and a trailing portion (7). The first coupling member (1) also includes a linear guide surface that, in the illustrated embodiment, is provided by the coupling end (3).

FIG. 20 illustrates a three dimensional view of the first coupling member (1) of FIG. 19. As can be seen, the first coupling member (1) includes a channel which intersects the planar face of the coupling end (3) to provide a coupling opening (34). Further, the guide (which also provides the coupling end in the illustrated embodiment), is provided by a collar (31) with a face (33) positioned forward of the linear cam surface (5). The coupling end (3) of the first coupling member (1) includes an annular groove (35) for positioning a rubber washer (241) which assists in forming a seal when the first (1) and second (11) coupling members are in engagement.

FIGS. 21 and 22, illustrate a front view and three-dimensional view (respectively) of the second coupling member (11) of an embodiment of the present invention for connection with the first coupling member (1) of FIGS. 19 and 20. The second coupling member (11) includes a body (12) having a forward coupling end (13) and a rearward connecting end (14) illustrated as connected to a fluid line (202).

The body (12) of the second coupling member (11) includes a follower (15) adapted to interact with the cam surface (5) of the first coupling member. The follower (15) has a leading portion (16) and a trailing portion (17). The second coupling member (11) also includes a guide follower, which in the illustrated embodiments, is provided by the coupling end (13) of the second coupling member.

Further illustrated in FIGS. 21 and 22 is a locking mechanism (111) which includes a recess (251) adapted to be manually engaged. The locking mechanism (111) includes two protrusions (252) each including a ramp surface (253). The locking mechanism includes at least one resilient arm (not shown) which is anchored to the body (12) of the second coupling member (11). The ramp surfaces (253) of the protrusions (252) facilitate the longitudinal movement of the locking mechanism (111) when the second coupling member (11) is brought into contact with the first coupling member (1). When transverse force is applied to the ramp surfaces, the resilient arm of the locking mechanism deflects and the protrusion (252) move longitudinally from a first position to a second position to allow positioning of the first coupling member (1) within the void (71) between the follower (15) and the guide follower (13/45). The protrusions (252) then return to their original, first, position to engage receiving portions (242—see FIG. 20) on the first coupling (1) member to restrain movement of the first (1) and second (11) coupling members relative to each other. To release the coupling members, the recess (251) of the locking mechanism (111) is manually engaged and the locking mechanism (111) is moved longitudinally to the second position allowing removal of the first coupling member (1) from the void (71). Upon release, the locking mechanism (111) is urged by the resilient arm(s) to return to its original, first, position.

The fluid line coupling of the present invention has a range of application, including, but not limited to, large fluid and gas lines three to six inches in diameter, small fluid lines such as garden hoses and hoses connected to domestic appliances such as washing machines, fluid lines for vehicles, irrigation lines and hydraulic lines.

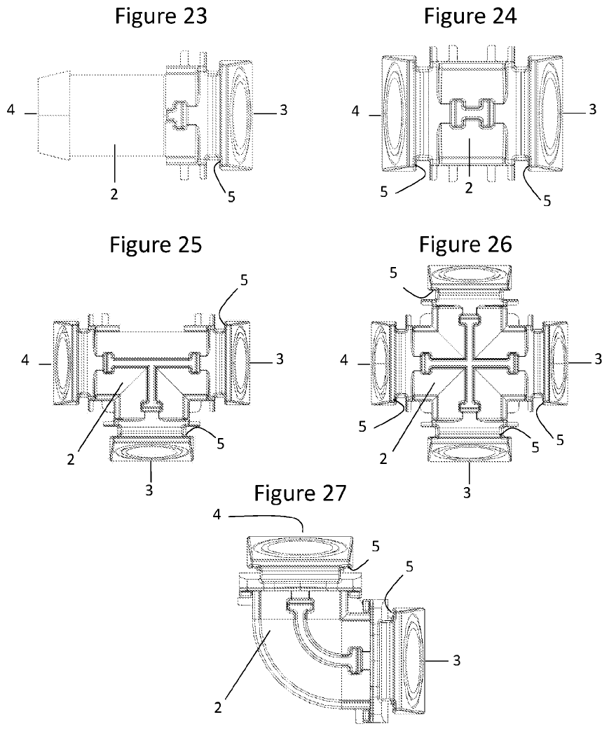

Embodiments of the first coupling members adapted for irrigation systems (amongst other applications) are illustrated in FIGS. 23 to 27. These figures shown several male connects which permit the interconnection of one or more fluid lines. Specifically, FIG. 23 discloses a single male connector, FIG. 24 discloses a double ended male connector, FIG. 25 discloses a three-way male connect, FIG. 26 discloses a four-way male connector and FIG. 27 discloses a double ended male elbow connector. All of the illustrated connectors are adapted to connect to the second coupling member illustrated in FIGS. 4, 8 and 12.

The illustrated fittings include a body (2) having a forward coupling end (3). In embodiments with multiple male ends (such as those in FIGS. 24 to 27) at least one of the male ends constitutes a rearward connecting end (4). Consequently, the term rearward connecting end, as used throughout the specification, performs the function of being positioned on the opposing end of the channel to a connecting end. The bodies (2) include at least one longitudinally-extending channel (not shown) passing therethrough to permit the flow of fluid from the connecting (4) end to the coupling end (3). The body (2) of the first coupling member includes a linear cam surface (5) inclined in a perpendicular direction relative to the longitudinal axis of the channel.

FIGS. 28 and 29 illustrate an embodiment of the present invention adapted for hydraulic, pneumatic and or other high pressure, fluid lines. Specifically, FIG. 28 illustrates an upper and lower three-dimensional view (respectively) of an embodiment of the first (1) and second (11) coupling members, adapted for high pressure applications. The first coupling member (1) of the coupling illustrated in FIG. 28 includes a body (2) having a forward coupling end (3) and a rearward connecting end (4). The body includes a longitudinally-extending channel passing therethrough to permit the flow of fluid from the connecting (4) end to the coupling end (3). The body (2) of the first coupling member includes a linear cam surface (5) inclined in a perpendicular direction relative to the longitudinal axis of the channel. The first coupling member further includes a locking mechanism (111) which includes a resilient arm (331) which is anchored to the body at one end (332).

The present invention is particularly useful in high pressure applications as the direction of engagement of the first (1) and second (11) coupling members is generally transverse to the direction of flow of fluid through the coupling. Consequently, fluid pressure within the line does not act to disengage the couplings. As such, the fluid line coupling of the present invention can with stand pressures of at least 400 psi.

The couplings for hydraulic, or other high pressure, fluid lines can be constructed of any suitable material including steel, stainless steel, aluminium, alloys of metal and other composite materials. The choice of material for construction of the couplings depends on the pressure rating of the coupling and will be determined by those skilled in the art.

FIGS. 30 and 31 provide three-dimensional views of a multi-channel connector in accordance with the present invention, including a first coupling member (1) and a second coupling connector (11). The connecting end (4) of the first coupling connector (1) includes four openings (342) for each of four parallel channels that pass through the first coupling connector (1). The connecting end (14) of the second coupling member (11) is illustrated in FIG. 31 and includes four openings (343) for each of four parallel channels that pass through the second coupling connector (11) and are in fluid communication with the four co-axial channels of the first coupling member (1).

Additionally illustrated in FIGS. 30 and 31 is a locking mechanism (111), which limits transverse movement of the second coupling member in the upward direction, thereby preventing uncoupling of the first (1) and second (11) coupling members.

Locking mechanisms (111) for restraining movement of first (1) and second (2) coupling members are illustrated in at least FIGS. 12, 14, 18, 21, 22, 28, 29, 30 and 31, however a comparison of various locking mechanisms (111) for use with the fluid line coupling of the present invention is provided in FIGS. 32 to 36.

FIGS. 32 and 33 illustrate a locking mechanism (111) including a resilient arm (331) anchored at one end (332) to the first coupling member (1). The locking mechanism (111) can be moved from a resting first locked position (as illustrated) whereby it engages an upper portion (335) of the second coupling member (11), to a second unlocked position (not shown) when a force is applied. Movement of the locking mechanism (111) to the second unlocked position disengages the locking mechanism from the second coupling member thereby allowing the second coupling member (11) to be disengaged from the first coupling member (1). When the force is removed from the locking mechanism (111), the resilient arm urges the locking mechanism back to the resting first locked position as shown on the left-hand side locking mechanism (111) of FIG. 35.

As illustrated in FIG. 33, a tab (334) is included to allow manual engagement of the locking mechanism (111) and to facilitate movement from the resting first locked position to the second unlocked position.

The locking mechanism as illustrated in FIGS. 32 and 33 can be comprised of any suitable material known in the art, including resilient plastics such as polyethylene or polypropylene, resilient and spring metals such as steel, stainless steel, aluminium and metal alloys.

FIG. 33 illustrates a locking mechanism (111) including a resilient arm (not shown) anchored at one end (254) to the second coupling member (11). The locking mechanism (111) can be moved from a resting first locked position (as illustrated) whereby it engages a lower portion (371) of the first coupling member (1), to a second unlocked position (not shown) when a force is applied. Movement of the locking mechanism (111) to the second unlocked position disengages the locking mechanism from the second coupling member there by allowing the second coupling member (11) to be disengaged from the first coupling member (1). When the force is removed from the locking mechanism (111), the resilient arm urges the locking mechanism back to the resting first locked position.

FIGS. 35 and 36 illustrate a locking mechanism (111) including an arm pivotally mounted (113) to the first coupling member (1). The locking mechanism (111) can be moved from a first locked position (as illustrated) whereby it engages an upper portion (381 and 18—FIGS. 35 and 36, respectively) of the second coupling member (11), to a second unlocked position (not shown) when a force is applied. Movement of the locking mechanism (111) to the second unlocked position disengages the locking mechanism from the second coupling member thereby allowing the second coupling member (11) to be disengaged from the first coupling member (1). The locking mechanism (111) of FIG. 38 is provided by a metal wire having two arms (112) and a bridge portion such that the arms of the locking mechanism (111) mount to each side of the first coupling member (1) and the bridge portion engages an upper recessed portion (381) of the second coupling member to prevent uncoupling of the first (1) and second (11) coupling members. The locking mechanism (111) of FIG. 39 is provided by two arms (112) mounted to each side of the first coupling member (1) and a bridge portion linking the two arms (112). The bridge portion includes a protrusion (114) adapted to engage the vertex (18) of the second coupling member (11).

As illustrated in FIG. 36, a tab (334) is included to allow manual engagement of the locking mechanism (111) and facilitate movement from the first locked position to the second unlocked position.

The locking mechanism as illustrated in FIGS. 38 and 39 can be comprised of any suitable material known in the art, including plastics such as polyethylene or polypropylene, metals such as steel, stainless steel, aluminium and composite materials such as metal alloys.

It is to be understood that various alterations, additions and/or modifications may be made to the parts previously described without departing from the ambit of the present invention, and that, in the light of the above teachings, the present invention may be implemented in a variety of manners as would be understood by the skilled person.

Future patent applications may be filed on the basis of the present application, for example by claiming priority from the present application, by claiming a divisional status and/or by claiming a continuation status. It is to be understood that the following claims are not intended to limit the scope of what may be claimed in any such future application.

1. A fluid line coupling including a first coupling member and a second coupling member;
each of the first and second coupling members including a body having a forward coupling end and a rearward connecting end, each body having a longitudinally-extending channel passing therethrough to permit the flow of fluid from the connecting end to the coupling end;
the body of the first coupling member including a linear cam surface inclined relative to the longitudinal axis of the channel;
the body of the second coupling member including a follower, the follower configured to engage the linear cam surface of the first coupling member,
wherein movement of the follower along the linear cam surface brings the coupling ends of the first and second coupling members into sealing engagement.

2. The fluid line coupling according to claim 1, wherein a portion of the follower is positioned forward of the coupling end of the second coupling member body.

3. The fluid line coupling according to claim 1, wherein the linear cam surface is provided by a lateral projection from the body of the first coupling member.

4. (canceled)

5. The fluid line coupling according to claim 1, wherein the follower is provided by a linear surface arranged to cooperatively interact with the linear cam surface of the first coupling member.

6. The fluid line coupling according to claim 1, wherein the linear cam surface is provided by a collar that projects from the body of the first coupling member to provide a planar surface intersected by the body of the first coupling member.

7. The fluid line coupling according claim 6, wherein the follower is provided by a planar surface arranged to cooperatively interact with the collar projecting from the first coupling member, and including a cleft portion for positioning of the body of the first coupling member therein.

8. (canceled)

9. The fluid line coupling according to claim 1, wherein the body of the first coupling member further includes a guide positioned forward of the linear cam surface, and the second coupling member includes a guide follower configured to operatively interact with the guide.

10. The fluid line coupling according to claim 9, wherein the guide is provided by a linear surface.

11. (canceled)

12. The fluid line coupling according to claim 10, wherein the linear surface of the guide mirrors the linear cam surface.

13-15. (canceled)

16. The fluid line coupling according to claim 9, wherein the guide is provided by a planar surface intersected by the channel to form a coupling opening, wherein the planar surface provides the coupling end of the first coupling member.

17-18. (canceled)

19. The fluid line coupling according to claim 9, wherein the guide follower includes a linear surface arranged to cooperatively interact with the guide of the first coupling member.

20. The fluid line coupling according to claim 9, wherein the guide follower is provided by a collar that projects from the second coupling member to provide a planar surface intersected by the body of the second coupling member.

21. The fluid line coupling according to claim 9, wherein the guide follower is provided by a planar surface intersected by the channel to form a coupling opening, wherein the planar surface of the guide follower provides the coupling end of the second coupling member.

22. The fluid line coupling according to claim 9, wherein the guide follower includes a linear surface and the follower includes a linear surface, wherein the linear surfaces of the guide follower and the follower tend toward each other at one end.

23. The fluid line coupling according to claim 22, wherein the linear surface of the guide follower and the linear surface of the follower converge at a vertex.

24. The fluid line coupling according to claim 1, including an engageable locking mechanism which, when engaged, restricts at least the transverse movement of the first and second coupling members relative to each other when coupled.

25. The fluid line coupling according to claim 23, including an engageable locking mechanism which, when locked, engages the vertex of the linear surface of the guide follower and the linear surface of the follower and restricts at least the transverse movement of the first and second coupling members relative to each other when coupled.

26. The fluid line coupling according to claim 24, wherein the locking mechanism is mounted on the body of the first or second coupling member and is movable from an unlocked position to a locked position which, when the first and second coupling members are coupled, engages the counterpart coupling member and limits transverse movement of the first and second coupling members relative to each other.

27. The fluid line coupling according to claim 24, wherein the locking mechanism slides in a longitudinal direction from a first locked position to a second unlocked position.

28. The fluid line coupling according to claim 24, wherein the locking mechanism is biased and allow movement from a resting first locked position, to a second unlocked position when a force is applied, then to return to the first position when the force is removed.
